(19) United States
(12) Patent Application Publication
(10) Pub. No.: US 2009/0242754 A1
(43) Pub. Date: Oct. 1, 2009

(54) Microchip and sample analysis method

(75) Inventor: Hisao Kawaura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Corporation, Tokyo (JP)

(21) Appl. No.: 12/385,081

(22) Filed: Mar. 30, 2009

(30) Foreign Application Priority Data
Mar. 31, 2008 (JP) 092900/2008

(51) Int. Cl. H01J 49/26

(52) U.S. Cl. 250/288

(57) ABSTRACT

The present invention provides a microchip and a sample analysis method in which mass analysis of a separated sample can be performed with high sensitivity without damaging resolution of a microchip. A microchip includes a channel formed on a substrate and sample collection portions which are formed along the channel, apart from the channel and are apart from each other.

This application is based upon and claims the benefit of priority from Japanese patent application No. 2008-092900, filed on Mar. 31, 2008, the disclosure of which is incorporated herein in its entirety by reference.

### BACKGROUND OF THE INVENTION

1. Field of the Invention

The present invention relates to a microchip and an analysis method using a mass spectrometer of a sample processed in a microchip, and more particularly, to a microchip and a sample analysis method in which a mass of a sample in a microchip can be analyzed with high spatial resolution and high sensitivity.

2. Description of the Related Art

Recently, as a micro-electro-mechanical system (MEMS) technology develops, research and development on a biochip, a chemical chip and a microfluid chip are being actively conducted. An attempt for realizing more accurate analysis by combining such a chip technology and a mass spectrometer and adding molecular weight information has been made.

International Patent Publication No. WO/2004-081555 discloses an example in which a microfluid chip which performs sample separation and a matrix-assisted laser desorption ionization (MALDI) type mass spectrometer are combined. FIGS. 1A to 1C illustrate a structure of a microfluid chip according to the relate art. A cross-shaped groove is formed on a glass substrate 101 and is used as a channel 102. A separation structure area 105 is formed in part of a longer directional channel. FIG. 1B is an enlarged view of an area indicated by a dotted line of FIG. 1A, and FIG. 1C is a cross-sectional view taken along a line A-A′ of FIG. 1B. In this instance, the separation structure area 105 includes an aggregate of cylindrical-shaped separation structures 106.

FIG. 2 illustrates an operation of the separation structure area 105. Two types of DeoxyriboNucleic Acid (DNA) molecules having different molecular sizes are used as a sample. Since a DNA molecule is negatively charged in an aqueous solution, if a positive voltage is applied to the right side of the separation structure area and a negative voltage is applied to the left side thereof, DNA molecules are electrophoresed toward a right direction. When DNA molecules are electrophoresed in the separation structure area 105, DNA molecules collide with the separation structures 106, and thus their moving speed is decreased. A DNA having a larger molecular size has a higher collision probability and lower mobility, and thus there occurs a moving speed difference due to a molecular size difference. Using this effect, a size separation of a DNA molecule can be performed.

FIGS. 3A to 3D illustrate a procedure for performing a size separation of a DNA molecule. First, as shown in FIG. 3A, a buffer solution such as Tris is introduced into a channel 102. Then, as shown in FIG. 3B, a sample 108 is introduced into one end of a shorter directional channel of the channel 102, and a voltage is applied to both ends of the channel of the shorter direction to introduce the sample 108 into the inside of the shorter directional channel. Next, as shown in FIG. 3C, a voltage is applied to both ends of a longer directional channel to introduce the sample at a crossing point of the longer directional channel and the shorter directional channel into the inside of the longer directional channel. Since the separation structure area 105 is formed in the longer directional channel, when the sample 108 arrives at the separation structure area, the sample 108 is subjected to a separation operation according to the molecular size. If the sample 108 is a mixture of two types of components (DNA molecules having different sizes), the sample 108 is separated into a DNA molecule (component 1) 109 having a high molecular weight and a DNA molecule (component 2) 110 having a low molecular weight as shown in FIG. 3D.

In order to detect a DNA molecule separated in the longer directional channel using a MALDI type mass spectrometer, it is required to add an ionization accelerator for supporting ionization of a high polymer and to form an ionization accelerator-molecule mixed crystal. An ionization accelerator is a liquid and can be added using various techniques such as a spraying technique, an ink jet technique, and a dispensing technique.

Before adding the ionization accelerator, additional processing can be performed. For example, in order to obtain DNA sequence information, a restriction enzyme solution can be added to perform DNA fragmentation in a desired sequence part, and thereafter an ionization accelerator can be added.

After an ionization accelerator-molecule mixed crystal is formed, a mass spectrum is obtained by irradiating an ultraviolet (LV) laser to a desired location of the channel 102. In this case, since a sample is separated in the channel 102 according to the molecule size, a mass spectrum which has the molecule size as a parameter can be obtained.

However, the microchip disclosed in International Patent Publication No. WO/2004-081555 has a problem which will be described below with reference to the drawing. FIG. 4 illustrates a sample distribution within a channel after an ionization accelerator is added into the separation structure area 105 of the channel 102. An ionization accelerator has a solution state, and it takes several seconds to several minutes to sufficiently mix an ionization accelerator with the sample 108 in the channel 102. Therefore, while the ionization accelerator is dried, the sample 108 is diffused or the ionization accelerator moves, so that a separation state of the sample 108 is diffused as shown in FIG. 4. Even when restriction enzyme treatment is performed after sample separation, the separation state is diffused.

As the separation state is diffused, two problems occur. Firstly, separation information can be lost. For easy description, a sample containing two components is illustrated in FIG. 4, but a sample can actually contain tens to thousands of types of components. Therefore, when the separation state is diffused, there occurs a problem in that components are mixed with each other and separation information is lost. Secondly, ionization efficiency deteriorates. When ionization is performed by laser irradiation, if many components exist within one laser spot, laser energy is distributed among many components, so that an amount of a signal corresponding to one component is decreased.

### SUMMARY OF THE INVENTION

The present invention addresses the above-identified, and other problems associated with conventional methods and apparatuses. An exemplary object of the present invention is to provide a microchip and a sample analysis method in which a mass of a separated sample can be analyzed with high spatial resolution and high sensitivity.

In order to achieve the above exemplary object, the present invention has the following features.

<Microchip>

A microchip in accordance with an exemplary aspect of the present invention includes a channel formed on a substrate and sample collection portions which are formed along the channel, apart from the channel and are apart from each other.

<Sample Analysis Method>

An exemplary aspect of the present invention is a sample analysis method using a microchip including dropping a solution into a channel of the microchip provided with sample collection portions which are formed along the channel, apart from the channel and are apart from each other, introducing a sample existing in the channel into the sample collection portions by a stream when dropping the solution, adding an ionization accelerator, and performing mass analysis of the sample.

An exemplary aspect of the present invention is a sample analysis method using a microchip including dropping an ionization accelerator into a channel of the microchip provided with sample collection portions which are formed along the channel, apart from the channel and are apart from each other, introducing a sample and part of the ionization accelerator which exist in the channel into the sample collection portions by a stream when dropping the ionization accelerator, irradiating a laser into the sample collection portions to perform ionization of a sample after drying the ionization accelerator, and analyzing the sample ionized in the irradiating by the use of a mass spectrometer.

### BRIEF DESCRIPTION OF THE DRAWINGS

FIG. 1A is a top view of a microchip disclosed in International Patent Publication No. WO/2004-081555, FIG. 1B is an enlarged view of an area defined by a dotted line of FIG. 1A, and FIG. 1C is a cross-sectional view taken along line A-A′ of FIG. 1B;

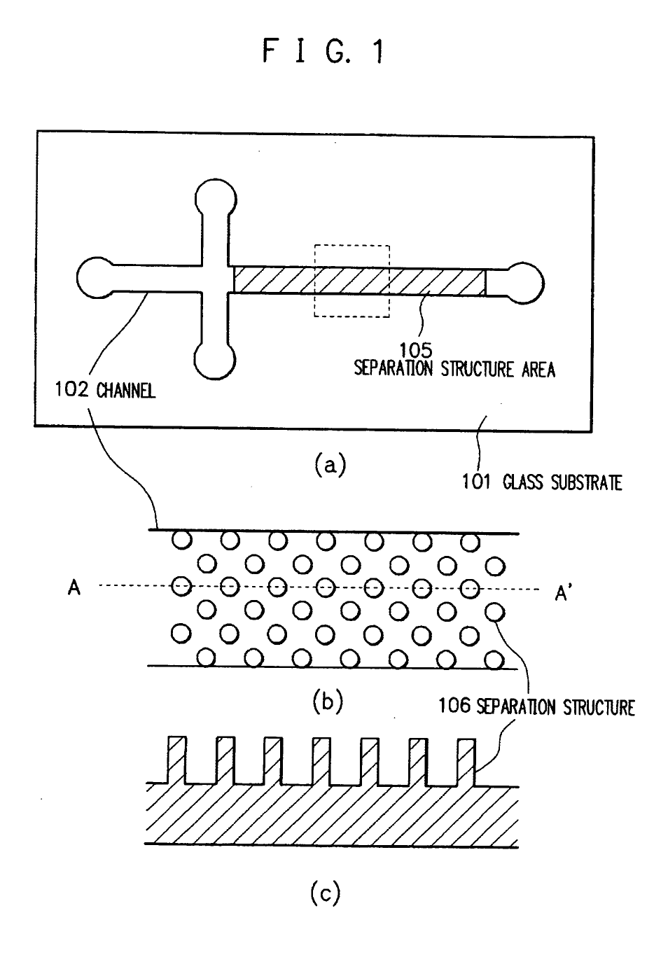

FIG. 2 is a view illustrating dependency of electrophoresis speed on a molecular size in a separation structure area of the microchip disclosed in International Patent Publication No. WO/2004-081555;

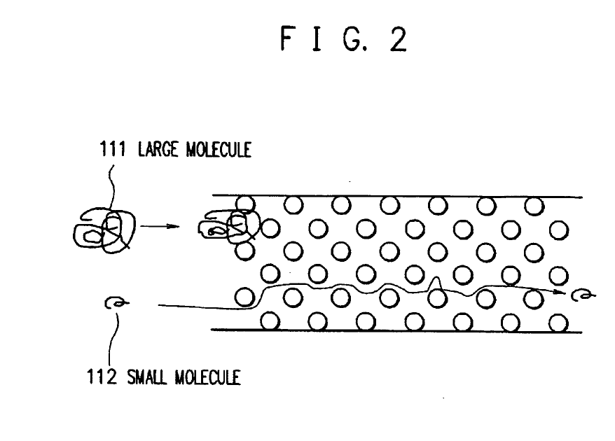

FIGS. 3A to 3D illustrate an electrophoresis procedure of the microchip disclosed in International Patent Publication No. WO/2004-081555, and FIG. 3A illustrates a process of introducing a buffer solution, FIG. 3B illustrates a process of introducing a sample into a shorter directional channel, FIG. 3C illustrates a process of beginning electrophoresis, and FIG. 3D illustrates a process of finishing electrophoresis;

FIG. 4 illustrates a sample distribution after adding an ionization accelerator into the channel in FIG. 3D;

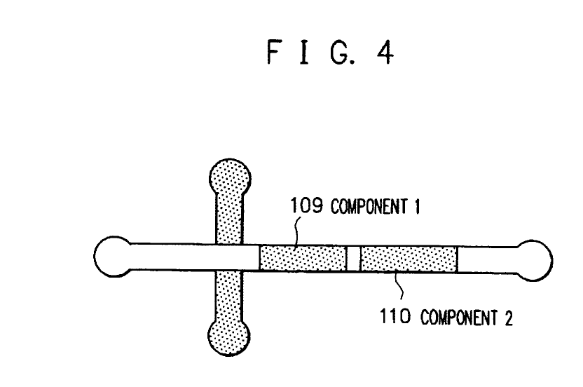

FIG. 5A is a top view illustrating a microchip according to an exemplary embodiment of the present invention, FIG. 5B is an enlarged view of an area defined by a dotted line of FIG. 5A, FIG. 5C is a cross-sectional view taken along a line B-B′ of FIG. 5B, and FIG. 5D is a cross-sectional view taken along a line A-A′ of FIG. 5B;

FIG. 6A is a top view illustrating an example discharging a solution into the microchip according to the exemplary embodiment of the present invention, and FIG. 6B is a cross-sectional view taken along a line B-B′ of FIG. 6A;

FIGS. 7A and 7B illustrate distributions of a component 1 and a component 2 before and after dropping a Tris buffer solution in the microchip according to the exemplary embodiment of the present invention, respectively;

FIG. 8A is a top view illustrating a microchip according to another exemplary embodiment of the present invention, FIG. 8B is a cross-sectional view taken along a line B-B′ of FIG. 8A, and FIG. 8C is a cross-sectional view taken along a line A-A′ of FIG. 8A;

FIG. 9A is a top view illustrating a microchip according to another exemplary embodiment of the present invention, FIG. 9B is a cross-sectional view taken along a line B-B′ of FIG. 9A, and FIG. 9C is a cross-sectional view taken along a line A-A′ of FIG. 9A;

FIG. 10A is a top view illustrating a microchip according to another exemplary embodiment of the present invention, FIG. 10B is a cross-sectional view taken along a line B-B′ of FIG. 10A, and FIG. 10C is a cross-sectional view taken along a line A-A′ of FIG. 10A; and

FIG. 11A is a top view illustrating a microchip according to another exemplary embodiment of the present invention, FIG. 11B is a cross-sectional view taken along a line B-B′ of FIG. 11A, and FIG. 11C is a cross-sectional view taken along a line A-A′ of FIG. 11A.

### DESCRIPTION OF THE EXEMPLARY EMBODIMENTS

Hereinafter, the exemplary embodiments of the present invention will be described in detail with reference to the accompanying drawings.

### Exemplary Embodiment 1

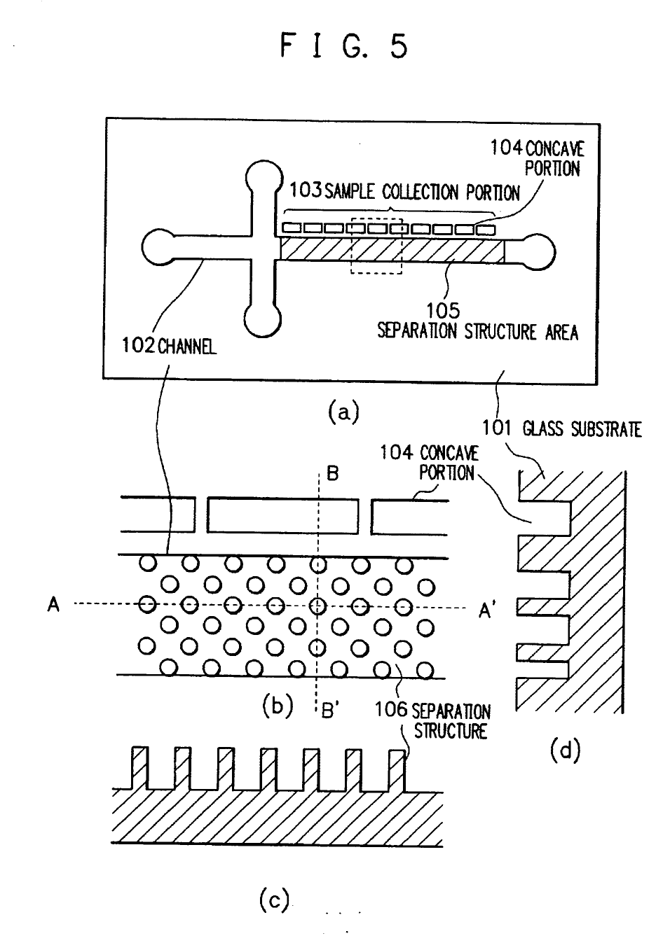

FIGS. 5A to 5D illustrate a configuration of a microchip according to an embodiment of the present invention. The exemplary embodiment of the present invention will be described in detail with reference to FIGS. 5A to 5D. As shown in the drawings, a groove is formed on a glass substrate 101 to form a channel 102. A separation structure area 105 is formed in part of the channel 102, and a sample collection portion 103 is formed in an area adjacent to the separation structure area 105. The sample collection portion 103 includes a plurality of concave portions 104 which are apart from each other. As shown in FIG. 5B, the separation structure area 105 includes a plurality of separation structures 106.

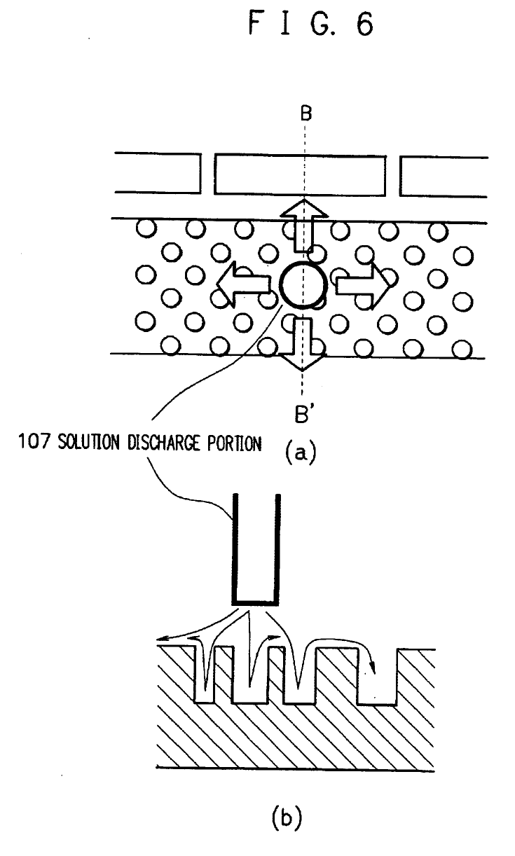

FIGS. 6A and 6B illustrate a state that a Tris buffer solution is added into the channel 102. Here, as a method for adding a Tris buffer solution, a dispenser is used. The dispenser is an apparatus which discharges a liquid from a front end of a fine needle-shaped structure by pressure and is widely used in applying, for example, an adhesive. FIGS. 6A and 6B illustrate a needle-shaped structure as a solution discharge portion 107. As the Tris buffer solution is discharged from the solution discharge portion 107, a sample existing on the channel 102 is transferred in all directions with a stream of a Tris buffer solution (see FIG. 6A). At this time, the Tris buffer solution and the sample which move toward the sample collection portion 103 are introduced into the concave portion 104. FIG. 6B is a cross-sectional view taken along a line B-B′ of FIG. 6A and illustrates a state that the Tris solution and the sample are introduced into the concave portion 104. The bottom of the concave portion 104 may be hydrophilic in order to smoothly introduce a Tris buffer solution and a sample.

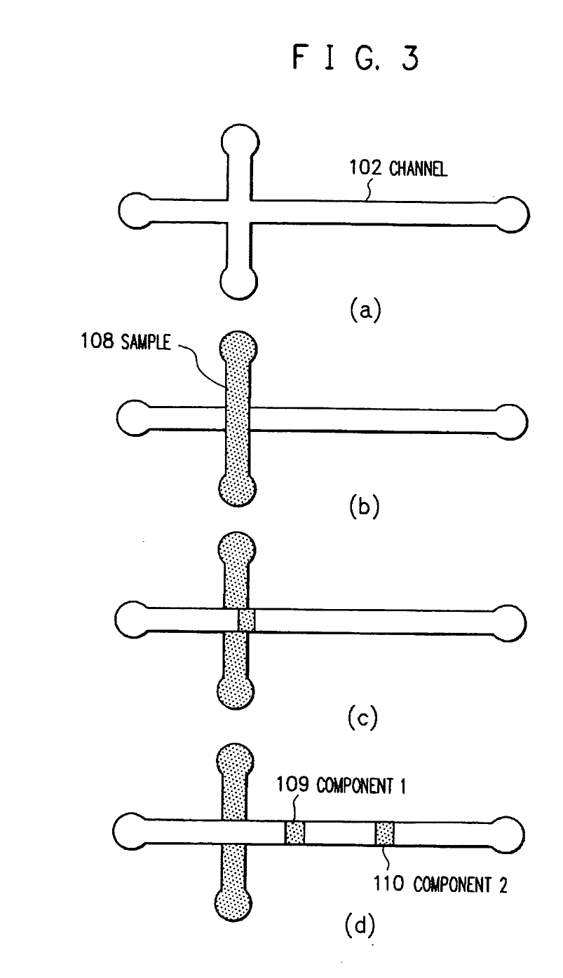

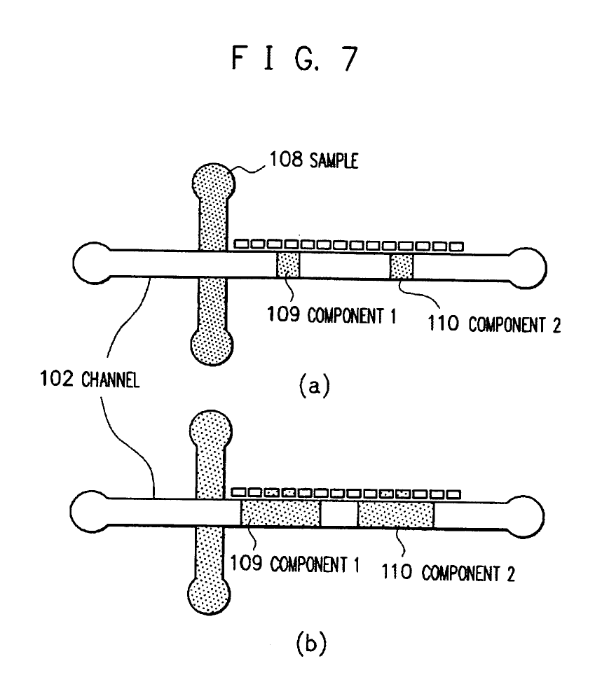

FIG. 7A illustrates a sample distribution after electrophoresis separation is performed as in FIGS. 3A to 3D using the microchip according to the exemplary embodiment. FIG. 7B illustrates a sample distribution after a Tris buffer solution is added into the channel 102 by the dispenser after electrophoresis separation is performed. While the Tris buffer solution (ionization accelerator) is dried, the distribution of a component 1 109 and a component 2 110 in the channel 102 is greatly spread due to movement of the Tris buffer solution and component diffusion inside the Tris buffer solution, but those which are introduced into the concave portions 104 when discharging the Tris buffer solution do not move or are not diffused between the concave portions 104, whereby the spread can be suppressed. Then, the ionization accelerator is added into each concave portion 104 using the dispenser, so that an ionization accelerator-sample mixed crystal can be formed while suppressing diffusion of a sample.

(Description on a Manufacturing Method)

Next, a method for manufacturing the microchip according to the exemplary embodiment of the present invention will be described. An electron beam drawing resist is first coated on the glass substrate 101 at the thickness of about 0.5 mm, an electron beam is irradiated by an electron beam drawing apparatus, and a development process is performed, thereby forming a resist pattern. In this case, the channel width is about 0.1 mm to 5 mm, the length of the longer directional channel is about 10 mm to 100 mm, and the length of the shorter directional channel is one several-th of the length of the longer directional channel. The separation structure 106 has a cylinder diameter of about 50 nm to 1,000 nm, and the closest distance between adjacent cylinders is about 50 nm to 1,000 nm. The distance between the longer directional channel 102 and the concave portion 104 is several microns to tens of microns. The longer directional channel and the concave portion 104 vertical thereto are several microns to hundreds of microns in length. The distance between the concave portions 104 is about several microns to tens of microns. Then, reactive ion etching using a CF4 gas or the like is performed using the resist as a mask to thereby form a groove on a surface of the glass substrate 101 at the depth of about 50 to 10 μm, and then the resist is removed by ashing.

The appropriate distance between the concave portions 104 and the lengths of the longer directional channel and the shorter directional channel have been described above, but they are not limited to the above-described values and can be appropriately adjusted. The length of the sample collection portion 103 is not limited, and can be, for example, one tenth of the separation structure area 105. If the length of each sample collection portion 103 (concave portion 104) gets shorter to minutely divide the separation structure area 105, more accurate separation information can be stored.

According to the exemplary embodiment, mass analysis with high spatial resolution and high sensitivity can be achieved since the sample 108 separated in the channel 102 of the microchip is transferred to the sample collection area 103 to prevent different components from being mixed. This is because the separated sample 108 in the channel 102 is introduced into the concave portion 104 in the sample collection portion 103 and, thus even though it is required a time for the sample 108 to be dried, mixing between the samples 108 existing in the different concave portions 104 does not occur.

Also, a Tris buffer solution can be smoothly introduced by making the bottom of the concave portion 104 being hydrophilic, thereby the sample 108 can also be smoothly introduced into the concave portion 104.

### Exemplary Embodiment 2

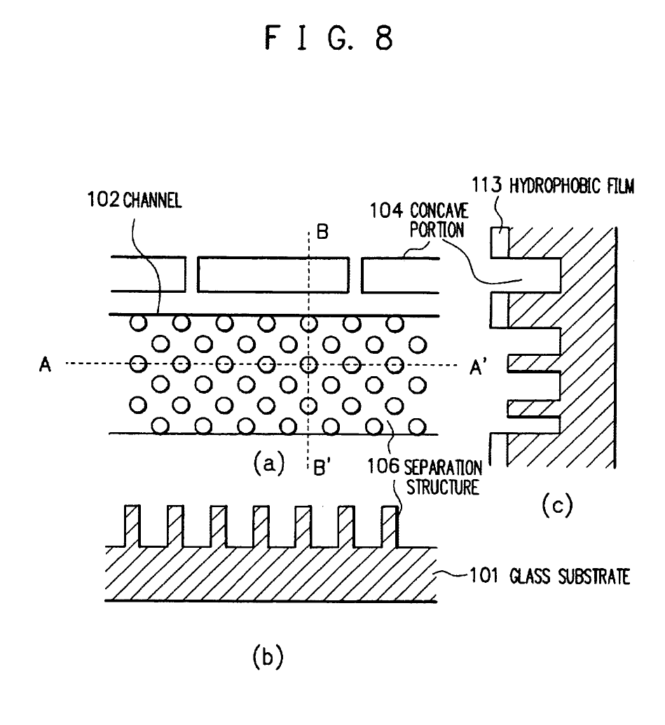

FIGS. 8A to 8C illustrate a configuration of a microchip according to another exemplary embodiment. A configuration of a microchip according to the exemplary embodiment which is different from that of the exemplary embodiment 1 described above will be described in detail with reference to FIG. 8. The exemplary embodiment is different from the exemplary embodiment 1 in the fact that areas excluding the channel 102 and the concave portion 104 are covered with a hydrophobic film 113 as shown in FIGS. 8A to 8C.

(Description on a Manufacturing Method)

In order to manufacture a microchip shown in FIGS. 8A to 8C, before coating an electron beam drawing resist, a process of treating oxygen plasma, a process of coating a hydrophobic film, and a baking process are added to the method for manufacturing the microchip according to the exemplary embodiment 1 described above.

According to the exemplary embodiment, areas excluding the channel 102 and the concave portion 104 are covered with the hydrophobic film 103. The hydrophobic film repels an aqueous solution. Therefore, when transferring the sample in the channel 102 to the concave portion 104, it is possible to more easily make a sample hardly remain between the channel 102 and the concave portion 104 compared to the exemplary embodiment 1 described above.

### Exemplary Embodiment 3

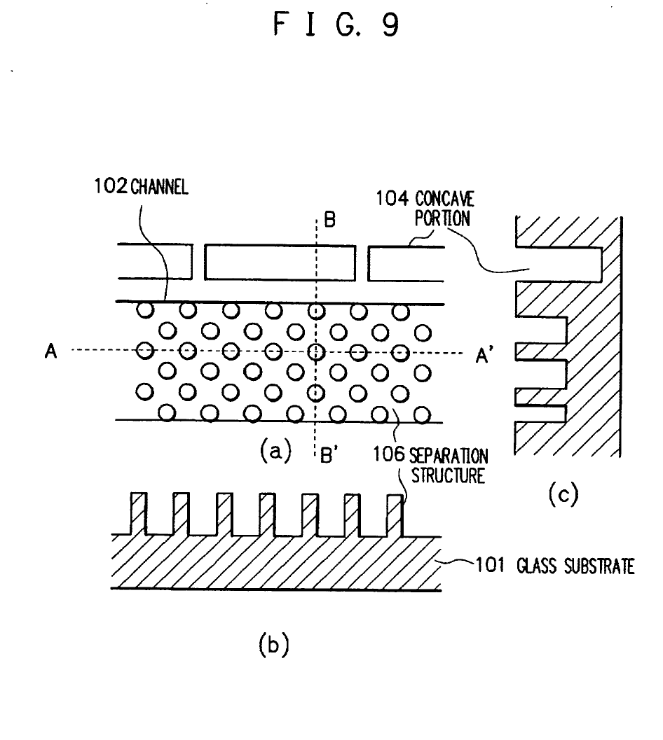

FIGS. 9A to 9C illustrate a configuration of a microchip according to another exemplary embodiment. A configuration of a microchip according to the exemplary embodiment which is different from that of the exemplary embodiment 1 described above will be described in detail with reference to FIGS. 9A to 9C. The exemplary embodiment is different from the exemplary embodiment 1 in the fact that the concave portion 104 is deeper in depth than the channel 102 as shown in FIGS. 9A to 9C.

(Description on a Manufacturing Method)

In order to manufacture a microchip shown in FIGS. 9A to 9C, in the method for manufacturing the microchip according the exemplary embodiment 1 described above, the channel 102 and the concave portion 104 are simultaneously formed. That is, the depths of the channel 102 and the concave portion 104 can be adjusted arbitrarily by individually performing electron beam lithography and a reactive ion etching.

According to the exemplary embodiment, since a quantity of samples per unit of the concave portion 104 area can be increased compared to the exemplary embodiment 1, signal cooperation for mass analysis can be improved.

### Exemplary Embodiment 4

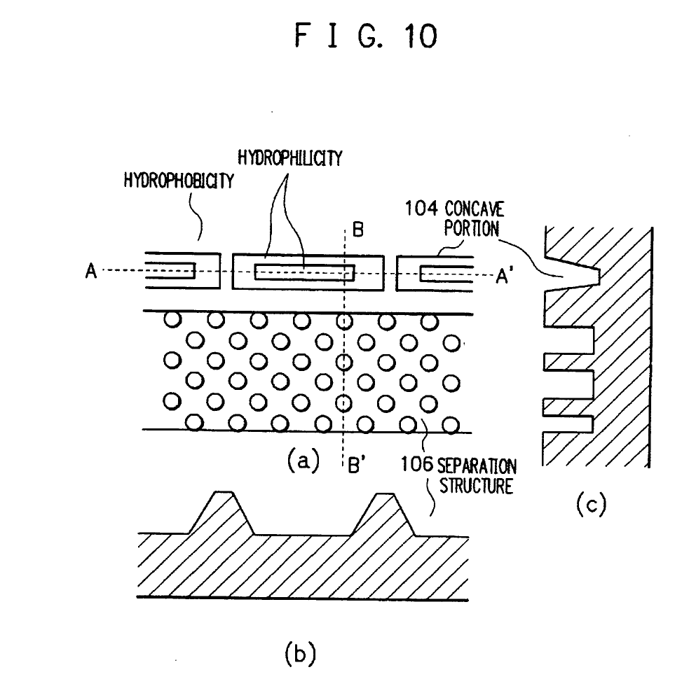

FIGS. 10A to 10C illustrate a configuration of a microchip according to another exemplary embodiment. A configuration of a microchip according to the exemplary embodiment which is different from that of the exemplary embodiment 1 described above will be described in detail with reference to FIGS. 10A to 10C. The exemplary embodiment is different from the exemplary embodiment 1 in the fact that the sample collection portion 103 has a shape in which its sectional area is smaller downward as shown in FIGS. 10A to 10C.

According to the exemplary embodiment, since the sample collection portion 103 has a shape in which its sectional area is smaller downward, a sample is collected closer to the bottom of the sample collection portion 103 as a sample is more dried, whereby concentration efficiency can be improved.

### Exemplary Embodiment 5

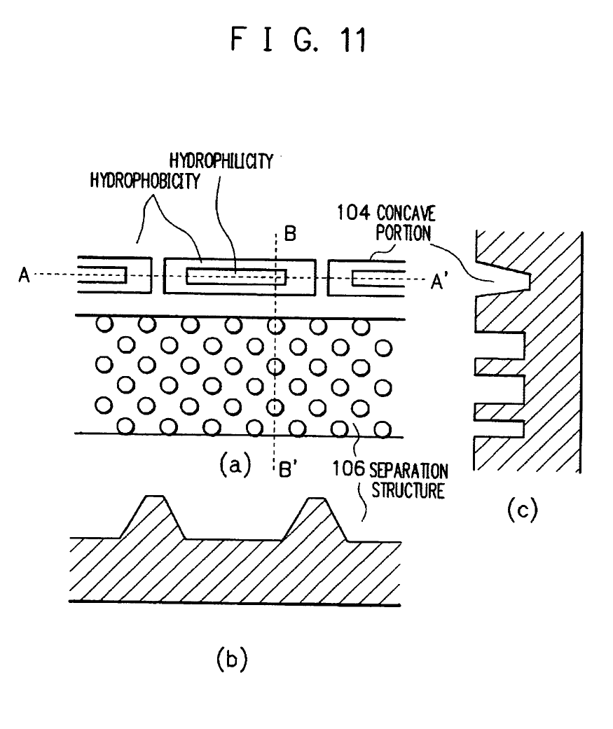

FIGS. 11A to 11C illustrate a configuration of a microchip according to another exemplary embodiment. A configuration of a microchip according to the exemplary embodiment which is different from that of the exemplary embodiment 1 described above will be described in detail with reference to FIGS. 11A to 11C. The exemplary embodiment is different from the exemplary embodiment 1 in the fact that the sample collection portion 103 has a shape in which its sectional area is smaller downward, and the side of the sample collection portion 103 is hydrophobic as shown in FIGS. 11A to 11C.

According to the exemplary embodiment, since the side of the sample collection portion 103 is hydrophobic, a sample is hardly attached to the side of the sample collection portion 103, and so more samples are collected on the bottom, whereby sample concentration efficiency can be improved.

### Exemplary Embodiment 6

In the exemplary embodiment, an exemplary embodiment in which restriction enzyme treatment is performed after sample separation will be described. The exemplary embodiment is different from the exemplary embodiment 1 in the fact that after collecting a sample in the concave portion 104, a restriction enzyme is added by a dispenser to perform fragmentation of a DNA molecule. EcoRI is used as a restriction enzyme and incubated for one hour at a temperature of 37° C., DHBA (ionization accelerator) is then added into the concave portion 104 by a dispenser, and mass analysis is performed to detect a signal of a fragmented DNA. A microchip according to any of the exemplary embodiments described above can be used.

In the exemplary embodiment, EcoRI is exemplarily used as a restriction enzyme, but a restriction enzyme can be appropriately selected by a sequence part which desires to be fragmented. Since a temperature and a time suitable for incubation depend on a type of a restriction enzyme, it is required to select a method suitable for a used restriction enzyme.

According to the exemplary embodiment, DNA fragmentation can be performed in a desired sequence part by adding a restriction enzyme solution, and DNA sequence information can be obtained by a fragmented DNA.

### Exemplary Embodiment 7

In the exemplary embodiment, an exemplary embodiment in which an ionization accelerator is used to move a sample to the concave portion 104. The exemplary embodiment is different from the exemplary embodiment 1 in the fact that an ionization accelerator is used instead of a Tris buffer solution to move a sample to the concave portion 104. DHBA is added into the channel 102 by a dispenser, so that the sample 108 in the channel 102 is introduced into the concave portion 104. A signal originated from a DNA can be obtained by irradiating a laser into the channel 102. A microchip according to any of the exemplary embodiments described above can be used.

According to the exemplary embodiment, since an ionization accelerator is used instead of a Tris buffer solution to move a sample to the concave portion 104, the number of times that a dispenser is used can be decreased, and operatability can be improved.

### EXAMPLE 1

A microchip is manufactured by the manufacturing method according to the exemplary embodiment 1 described above. The lengths of the longer directional channel and the shorter directional channel are 40 mm and 20 mm, respectively, the width and the depth are 1 mm and 0.4 micron, respectively. The longer directional channel and the shorter directional channel cross each other at a distance of 10 mm from one end of the longer directional channel, and the separation structure area 105 with the length of 25 mm is formed at an offset of 1 mm from the crossing point. The separation structure area 105 has an array arrangement of the cylindrical-shaped separation structures 106 as shown in FIG. 5B, the cylinder diameter is 200 nm, and the closest distance between adjacent cylinders is 100 nm. A distance between the concave portion 104 and the channel 102 is 0.5 mm, the lengths of the longer directional channel 102 and the concave portion 104 vertical thereto are 0.4 mm, and the distance between adjacent concave portions 104 is 0.1 mm.

Two types of DNAs (sequence lengths of 1 kbp and 10 kbp) labeled with a phosphor (YOYO-1), which are dissolved in a Tris buffer solution, are used as the sample 108. The sample 108 is performed electrophoresis according to the processing procedure of FIGS. 3A to 3D. Platinum electrodes are inserted into ends of the longer directional channel 102, and a voltage of 200 V is applied to perform electrophoresis of a DNA. After performing electrophoresis for five minutes, the sample is dried, and ultraviolet rays were irradiated to the microchip. A fluorescent area with the width of 1.5 mm by a 10 kbp DNA and a fluorescent area with the width of 1.6 mm by a 1 kbp DNA are observed at a location of 10.3 mm and a location of 19.5 mm from the channel cross point, respectively. Then, while dropping a Tris buffer solution by a dispenser, a dropping location is moved along the separation structure area 105. After drying a Tris buffer solution (for five minutes), ultraviolet rays are irradiated again, and a separation pattern is confirmed by fluorescence. As a result of enlarging the distributions of 1 kbp and 10 kbp DNAs in the channel 102, it is understood that fluorescent distributions become one.

On the other hand, 5 concave portions 104 at a location adjacent to a separation location of a 1 kbp DNA emit fluorescence, and 6 concave portions 104 at a location adjacent to a separation location of a 10 kbp DNA emit fluorescence, and 12 concave portions 104 between the concave portions 104 which emit fluorescence did not emit fluorescence. It is understood that mixing of different two components does not occur in the concave portions 104 unlike the inside of the channel 102.

### EXAMPLE 2

A microchip is manufactured by the manufacturing method according to the exemplary embodiment 2 described above. Unlike the microchip according to the exemplary embodiment 1 described above, the hydrophobic film 113 is formed on other areas than the channel 102 and the concave portion 104. The remainder of the sample on a chip surface can be completely removed.

### EXAMPLE 3

A microchip is manufactured by the manufacturing method according to the exemplary embodiment 3 described above. Unlike the microchip according to the exemplary embodiment 1 described above, the concave portion 104 with the depth of about 1 micron which is deeper than the depth of the channel 102 is formed. DHBA is added as an ionization accelerator by a dispenser with respect to a DNA introduced into the concave portion 104 by a Tris buffer solution, so that the signal strength which is three times stronger than a case where the concave portion 104 has the same depth (0.4 micron) as the channel 102 is obtained in both 1 kbp and 10 kbp molecules.

The exemplary embodiments of the present invention have been described above, and in all of the exemplary embodiments of the present invention, the cross-shaped channel which includes the separation structure area 105 having an aggregate of the separation structures 106 is used. In the separation structure area 105, separation is performed depending on the molecule size. However, the present invention is not limited to the microchips of the above-described forms or the separation method based on the molecule size. Also, the present invention is not limited to a DNA as a target molecule.

For example, isoelectric point separation can be performed in a microchip, and in this case, a straight line type channel can be used instead of a cross-shaped channel. Protein can be spatially separated according to an isoelectric point by introducing a positive carrier into a channel together with a sample, introducing acidic and alkaline reagents to both ends of the channel and applying a voltage. In this case, the separation structure 106 used in the exemplary embodiments described above is not necessary.

In the exemplary embodiments described above, glass is used as a major material of a microchip, but a silicon substrate on which a silicon oxide film is coated or a material such as plastic can be used.

In the exemplary embodiments described above, the concave portion 104 is described as the sample collection portion 103, but the sample collection portion 103 is not limited to the concave portion 104 and can employ shapes other than a concave shape. Also, in the present invention, a shape of the sample collection portion 103 is not limited to a shape which is surrounded by a convex portion.

In a microchip according to another exemplary embodiment of the present invention, the sample collection portion includes a concave portion.

In a microchip according to another exemplary embodiment of the present invention, the sample collection portion is surrounded by a convex portion.

In a microchip according to another exemplary embodiment of the present invention, the sample collection portion includes the bottom being hydrophilic.

In a microchip according to another exemplary embodiment of the present invention, the sample collection portion includes the side being hydrophilic.

In a microchip according to another exemplary embodiment of the present invention, the sample collection portion includes the side being hydrophobic.

In a microchip according to another exemplary embodiment of the present invention, areas other than the channel and the sample collection portion are hydrophobic.

In a microchip according to another exemplary embodiment of the present invention, the concave bottom of the sample collection portion is deeper than the bottom of the channel.

A sample analysis method according to another exemplary embodiment of the present invention is a method using the microchip and includes dropping a solution into the channel, inducing a sample in the channel into the sample collection portion by a stream when dropping the solution, fragmenting the sample by enzyme treatment, adding an ionization accelerator, and performing mass analysis of the sample.

According to the present invention, a sample separated in the channel of the microchip is transferred to the sample collection area to prevent different components from being mixed, whereby mass analysis with high spatial resolution and high sensitivity can be achieved.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A microchip comprising:
a channel formed on a substrate; and
sample collection portions which are formed along the channel, and are apart from the channel,
wherein the sample collections are apart from each other.

2. The microchip of claim 1, wherein the sample collection portion comprises a concave portion.

3. The microchip of claim 1, wherein the sample collection portion is surrounded by a convex portion.

4. The microchip of claim 1, wherein the sample collection portion comprises the bottom being hydrophilic.

5. The microchip of claim 1, wherein the sample collection portion comprises the side being hydrophilic.

6. The microchip of claim 1, wherein the sample collection portion comprises the side being hydrophobic.

7. The microchip of claim 1, wherein areas other than the channel and the sample collection portion are hydrophobic.

8. The microchip of claim 1, wherein the bottom of the sample collection portion is deeper than the bottom of the channel.

9. A sample analysis method using a microchip comprising:
dropping a solution into a channel of the microchip provided with sample collection portions which are formed along the channel, apart from the channel and are apart from each other;
introducing a sample existing in the channel into the sample collection portions by a stream when dropping the solution;
adding an ionization accelerator; and
performing mass analysis of the sample.

10. The sample analysis method of claim 9, further comprising fragmenting the sample by enzyme treatment.

11. The sample analysis method of claim 9, wherein the sample collection portion comprises a concave portion.

12. The sample analysis method of claim 9, wherein the sample collection portion is surrounded by a convex portion.

13. The sample analysis method of claim 9, wherein the sample collection portion comprises the bottom being hydrophilic.

14. The sample analysis method of claim 9, wherein the sample collection portion comprises the side being hydrophilic.

15. The sample analysis method of claim 9, wherein the sample collection portion comprises the side being hydrophobic.

16. The sample analysis method of claim 9, wherein areas other than the channel and the sample collection portion are hydrophobic.

17. The sample analysis method of claim 9, wherein the bottom of the sample collection portion is deeper than the bottom of the channel.

18. A sample analysis method using a microchip comprising:
dropping an ionization accelerator into a channel of the microchip provided with sample collection portions which are formed along the channel, apart from the channel and are apart from each other;
introducing a sample and part of the ionization accelerator which exist in the channel into the sample collection portions by a stream when dropping the ionization accelerator;
irradiating a laser into the sample collection portions to perform ionization of a sample after drying the ionization accelerator; and
analyzing the sample ionized in the irradiating by use of a mass spectrometer.
